(19) United States
(12) Patent Application Publication
(10) Pub. No.: US 2017/0143013 A1
(43) Pub. Date: May 25, 2017

(54) HIGH PRESSURE PASTEURIZING OF WHOLE MUSCLE MEATS

(71) Applicant: CARGILL, INCORPORATED, Wayzata, MN (US)

(72) Inventors: Russell Lanzrath, Newton, KS (US); David R. McKenna, Benton, KS (US); Brock Aaron Zentz, Andover, KS (US)

(21) Appl. No.: 15/362,326

(22) Filed: Nov. 28, 2016

Related U.S. Application Data
(63) Continuation of application No. 13/700,579, filed on Jan. 25, 2013, now abandoned.
(60) Provisional application No. 61/349,388, filed on May 28, 2010.

(51) Int. Cl. A23L 3/015; A23B 4/00

(52) U.S. Cl. CPC A23L 3/0155; A23B 4/00; A23V 2002/00

(57) ABSTRACT

A process for preserving fresh meat which includes the steps of a) packaging fresh meat in a sealed package; b) placing the packaged fresh meat in a pressurization vessel and closing the vessel; c) pressurizing the pressurization vessel containing the packaged fresh meat to an elevated pressure of at least 50,000 psi pressure so that the packaged fresh meat is placed under the elevated pressure; d) maintaining the elevated pressure on the packaged fresh meat for a time of from 1 to 300 seconds and at a temperature of from −2° C. to 8° C.; e) reducing the pressure on the packaged fresh meat to ambient pressure; and f) removing the meat from the pressurization vessel. Pathogens are effectively killed using this process, providing manufacturing efficiencies and longer product shelf life as compared to other meat handling procedures.

### CROSS REFERENCE TO RELATED APPLICATION

This application claims the benefit of U.S. Provisional Patent Application No. 61/349,388 filed May 28, 2010 entitled HIGH PRESSURE PASTEURIZING OF WHOLE MUSCLE MEATS, which is hereby incorporated by reference in its entirety.

### FIELD OF THE INVENTION

The present invention relates to the preservation of whole muscle meat. In particular, the present invention relates to preservation of whole muscle meat by application of high pressure.

### BACKGROUND OF THE INVENTION

Whole muscle meat products are typically distributed in a fresh state. While a frozen product has significantly longer shelf life compared to fresh distribution (typically 120-365 days versus 25 days or less), there is a perceived consumer acceptance for “fresh” as well quicker cooking times since one is cooking from 1-8° C. for fresh instead of from −18-0° C. for frozen. More specifically, one is generally coking from 1.66-7.22° C. for fresh instead of from −17.77-0° C. for frozen. However, the significantly shorter shelf life of fresh products compared to frozen products gives rise to inventory risks.

If there is a supply interruption, there is not a way to keep a large inventory on hand. Further, there is an increased risk of potential contamination by pathogens, such as E. coli or Salmonella. This risk is further increased where there has been some intrusion into the meat muscle. For example, if the meat has been injected with a marinade, the injection increases the potential for contamination. Similarly, if the meat has been needle tenderized, there is an increased potential for pathogen contamination.

According to the U.S. Pat. No. 6,033,701, the use of pressure for sterilization of food was discovered early in the 20^{th} century. Early reports of the use of pressure in sterilization focused on fruits. However, high pressure has been used for treatment of certain foods, such as fish meat and/or kneaded fish meat products (e.g. U.S. Pat. No. 6,440,484) or raw food products, such as raw shellfish (see, e.g., U.S. Pat. No. 6,537,601).

Early methods for the treatment of food at a high pressure, such as those described in U.S. Pat. Nos. 5,593,714 and 6,033,701, require a treatment at a pressure of 25,000 psi and a temperature of 18-23 degrees C. for a time period of at least 5 days, or to at least 70 MPa pressure so that said foodstuff or said feedstuff is placed under said pressure, maintaining said pressure on said container and said foodstuff or said feedstuff for more than 12 hours at a temperature of between 18 and 23 degrees centigrade, respectively. The very long retention time of these products under pressure as required in these patents is not acceptable for mass production purposes.

Additionally, companies such as American Pasteurization Company and Avure Technologies, use or provide equipment to carry out High Pressure Processing of foods. These companies are careful to note that they are not food companies, but are equipment suppliers to food producers. A number of patents have been granted to these companies, all focusing on the equipment and the processes for use of the equipment.

In 2001, the U.S. Federal Department of Agriculture (FDA) Center for Food Safety and Applied Nutrition published an Evaluation and Definition of Potentially Hazardous Foods that, among other strategies, discussed the use of High Pressure Processing for Microbial Inactivation. The report stated:

“Ground beef can be pasteurized by HPP to eliminate E. coli O157:H7, Listeria spp., Salmonella spp., or Staphylococcus spp. Much more work is required to develop a suggested hold time at 580 MPa due to the potential for tailing. Changes in product color and appearance may limit the usefulness of HPP treatment pressures above 200 to 300 MPa.”
http://www.cfsan.fda.gov/˜comm/ift4-5.html

Further study of use of High Pressure Processing in inactivation of various microflora in inoculated ground beef has been carried out since the FDA report. For example, an article entitled “High Pressure Inactivation of Citrobacter freundii, Pseudomonas fluorescens and Listeria innocua in Inoculated Minced Beef Muscle,” A. Carlez et al.; Lebensm.-Wiss.u.-Technol., 26, pp. 357-363 (1993) describes pressure treatment of minced beef under a range of pressures for 20 minute periods at various temperatures. This article notes that the greatest reduction in microorganisms was observed at 50° C. Similarly, an article entitled “High-pressure destruction kinetics of Clostridium sporogenes spores in ground beef at elevated temperatures,” Songming Zhu et al.; International Journal of Food Microbiology, 126 (2008) pp. 86-92, combined high pressure treatment with heat, 80-100° C., to provide effective destruction of spores.

U.S. Publication No. US2009/0232959 discusses the use of High Pressure Processing in relation to whole muscle meat as a method for increasing tenderness. Specifically, fresh meat is a vacuum package and then subject to hydrostatic pressure between 1,000 psi and 39,000 psi. This leads to a significant decrease in sheer force, a common measure of tenderness.

U.S. Provisional Application No. 61/245,934, filed on Sep. 25, 2009, discusses the use of high pressure processing in relation to frozen ground meat products. Specifically, that application discusses a process for preserving frozen ground meat including subjecting the ground meat to an elevated pressure for a time from 1 to 300 seconds and at a temperature from about −45.55° to about 7.22° C. U.S. Provisional Application No. 61/292,310, filed Jan. 5, 2010, discusses the high pressure pasteurization of fresh ground meats. That application discloses the use of high pressure at a temperature from −2° C. to 8° C. for 1 to 300 seconds to control the potential pathogens in the ground meat products. More specifically, that application discloses the use of high pressure at a temperature of −1.11° to 7.22° C. for 1 to 300 seconds to control the potential pathogens in the ground meat products.

The preservation of vegetables in contact with a noble gas, a mixture of noble gases or a mixture containing at least one noble gas is described in U.S. Pat. No. 6,342,261.

### SUMMARY OF THE INVENTION

The process described herein utilizes High Pressure Processing to pasteurize fresh cuts of meat. In the present process, fresh whole muscle meat is packaged in a sealed package. This package is placed in a pressurization vessel, which is pressurized to at least 50,000 psi pressure, so that the packaged fresh ground meat is placed under elevated pressure. This elevated pressure is maintained for a time of from 1 to 300 seconds, and the packaged fresh meat is at a temperature of from −2° C. to 8° C. during the pressurization process. More specifically, the packaged fresh meat is at a temperature of from −1.11° to 7.22° C. during the pressurization process. The pressure on the packaged fresh whole muscle meat is then reduced to ambient pressure, and the packaged meat is removed from the pressurization vessel.

The present invention provides an advantage in preservation of whole muscle meat products by efficiently killing pathogens in the meat and decreasing the risk of pathogen contamination of food eaten by the consumer. Another aspect addresses spoilage organisms which can introduce off odors and flavors in meat even before they are unhealthy for consumption. The present invention can improve the length of time that a meat product is at high quality as compared to prior art processes by efficiently killing the spoilage organisms. Further, use of high pressure processing of whole muscle meat can advantageously clutch pathogens and spoilage organisms without the use of chemical treatments or incorporation of preservatives that some customers may find to be objectionable.

In an embodiment of the present invention, whole muscle meat can be prepared using less than half of the amount of preservatives (such as lactates or salt) as compared to like meat products that have not been processed using pressure as described herein. In an embodiment of the present invention, the meat additionally contains non-endogenous antimicrobial treatment chemicals to further decrease the risk of pathogen contamination of food eaten by the consumer. In an embodiment of the present invention, the fresh meat is free of non-endogenous antimicrobial treatment chemicals. In another embodiment of the present invention, the fresh meat is free of stabilizers, preservatives and similar processing aids.

Surprisingly, the pressure used in the present process under the conditions of treatment has been found to be effective in killing pathogens in the meat in a very short period of time, enabling this process to be used in production scale settings. Because the pathogen killing step can be carried out in time of less than 300 seconds, preferably less than 150 seconds, and most preferably less than 75 seconds, large scale production facilities can use the present process without undue delay in production. Additionally, the product that is provided exhibits an excellent shelf life due to the completeness of the micro kill and sanitary hand link conditions after treatment. A conventional meat product has a typical shelf life of up to 26 days. In an embodiment of the present invention, the packaged fresh meat has a shelf life of at least 60 days, and potentially at least 90 days.

Additionally, the process is surprisingly effective even though the meat is not at an elevated temperature. Thus, pathogens can be effectively killed in fresh meat while at the same time maintaining preferred processing conditions whereby the meat never exceeds the temperature of 7.22° C. (50° F.). This allows meat producers to establish a Hazard Analysis and Critical Control Point (HACCP) program using recognized safe temperature handling protocols without the need to heat the meat. The present invention thus provides a process whereby meat can be processed without transitioning the meat through undesirable temperature ranges such as temperatures above conventional refrigeration temperatures and below cooking temperatures.

### BRIEF DESCRIPTION OF THE DRAWINGS

FIG. 1 is an aerobic plate count measurement as a function of time after high pressure pasteurization of beef strip loins which had been aged 35 days prior to pasteurization.

FIG. 2 is an aerobic plate count measurement as a function of time after high pressure pasteurization of beef strip loins which had been aged 26 days prior to pasteurization.

### DETAILED DESCRIPTION OF PRESENTLY PREFERRED EMBODIMENTS

The embodiments of the present invention described below are not intended to be exhaustive or to limit the invention to the precise forms disclosed in the following detailed description. Rather, a purpose of the embodiments chosen and described is so that the appreciation and understanding by others skilled in the art of the principles and practices of the present invention can be facilitated.

The meat treated in accordance with the present invention may be any variety of meat from any species. Suitable meats include those obtained from bovine, porcine, equine, caprine, ovine, avian animals, or any animal commonly slaughtered for food production. Bovine animals may include, but are not limited to, buffalo, and all cattle, including steers, heifers, cows, and bulls. Porcine animals may include, but are not limited to, feeder pigs and breeding pigs, including sows, gilts, barrows, and boars. Ovine animals may include, but are not limited to, sheep, including ewes, rams, wethers, and lambs. Poultry may include, but are not limited to, chicken, turkey, and ostrich. Preferably the meat is bovine meat, and most preferably beef.

The meat is processed in a conventional manner. In most large scale processing systems, the meat is first processed into large primal portions (“primal”), and the primals are then later cut into smaller portions.

In an embodiment of the present invention, the fresh meat contains additional components. For example, in an embodiment of the invention, the fresh meat may be injected with a solution of water, salt, and sodium phosphate up to 12%.

In an embodiment of the invention, the meat has been subjected to further invasive processing steps. For example, the meat may be needle tenderized by a process where an array of needles or thin blades are inserted into the muscle to mechanically tenderize by means of physically disrupting the muscle fibers. This is commonly accomplished using a commercial blade tenderizer (Ross Industries, Inc; www.rossindinc.com) or alternately may be accomplished by a hand-held jaccarding apparatus.

The meat is divided into appropriate portions and packaged in a sealed package. In an embodiment of the invention, the packaged fresh meat is a primal. In another embodiment of the invention, the packaged fresh meat is in a meat portion (i.e., total amount of meat in the package) of from 25 to 10 pounds of meat, and in another embodiment from 10 to 1 pounds of meat, and in another embodiment in a meat portion from 16 to 1 ounces of meat. Thus, the meat portion may be sized for use by institutional costumers (restaurant, food service, or commercial users) or for the home consumer. The meat may be provided in any format, such as in the foiin of whole loins, individual steaks, and the like.

The package is an air-tight package. It may be suitable for storage and transport. In another embodiment, the package may be suitable for storage, transport and presentation to the consumer. The packaging may be of a bulk, shipping, or individual serving type. Examples of packaging include those who the package is a formable pouch, injectable pouch, sealable pouch, formable tray, vacuum sealable tray or pouch, heat formable tray or pouch, film covered tray, vacuum sealed film covered product, gas flushed pouch, bag or tray, or vacuum sealable bag. In an embodiment, the product is package vacuum roll stock.

Preferably, the meat is packaged in a sealed package having a vacuum environment, meaning the pressure in the package is less than atmospheric pressure. This reduces the exposure of the meat to oxygen. Reduction of the exposure of meat to oxygen is advantageous, because this reduces oxidation of the meat. If the meat is not packaged in vacuum, preferably the environment within the meat packaging is purged of oxygen. In an embodiment, the gas environment comprises a gas selected from carbon dioxide, nitrogen, carbon monoxide, nitrous oxide, hydrogen, neon, argon, krypton, xenon and mixtures thereof.

The packaged fresh meat product may then be placed in a pressurization vessel and pressure may be applied in an appropriate manner. Equipment used to treat materials using high pressure is described, for example, in U.S. Pat. Nos. 7,220,381; 5,316,745; 5,370,043; 7,310,990; and 7,096,774.

A preferred process comprises submerging the packaged fresh meat in a liquid (often water) within an enclosed vessel. Pressure is then generated either by pumping more liquid into the pressure vessel or by reducing the volume of the pressure chamber. This pressure is unifonnily distributed over all materials in the vessel, and even packages with headspace do not ordinarily burst. The pressurization vessel containing the packaged fresh meat is pressurized to an elevated pressure of at least 50,000 psi. Preferably, the elevated pressure is from 50,000 psi to 90,000 psi, more preferably from 60,000 psi to 90,000 psi, and most preferably from 70,000 psi to 87,000 psi. The packaged fresh meat product is treated under elevated pressure for a time of from 1 to 300 seconds, more preferably for a time of from 30 to about 150 seconds, and most preferably for a time of from about 45 to about 70 seconds.

The pressurization is carried out at a temperature of from −2 to 10° C. In another embodiment, the pressurization is carried out at a temperature of from −1.11° C. to 10° C. Preferably, the temperature of the fresh meat is never above 7.22° C. (50° F.), and more preferably never above about 4.44° C. (40° F.) during the entire production process. Optionally, the entire process is carried out with the meat at a temperature from −2° C. to 8° C. The entire process could also be carried out with the meat at a temperature from −1.11° C. to 7.22° C.

Because the fresh meat product is already in a sealed package before treatment, the meat is not touched again or exposed to the air or unsanitary conditions until the package is opened by the consumer.

In a preferred embodiment of the present invention, the packaged fresh meat is submerged in liquid during the pressure treatment step. If the packaging is faulty, the present pressure treatment advantageously exposes any packaging defects such as pinholes, usually by permitting a detectable amount of liquid to enter into the package. Thus the present invention beneficially operates to reveal defective packaging that would lead to premature product spoilage if not detected.

### EXAMPLES

### Example 1

USDA select beef, boneless strip loins were procured. The strip loins were trimmed of external fat accord to standard industry practices, leaving approximately ⅛″ of external fat. The strip loins were tenderized using needle tenderization a single time according to standard industry practices using a Ross TC700W; www.rossindinc.com. The strip loins were then allowed to age 14 days, and were portioned into one inch steaks using a band saw with a boneless blade. The steaks were vacuumed packaged in a four across Multi-Vac roll stock machine, model R230.

High pressure pasteurization processing was performed at the American Pasteurization Company facility in Milwaukee, Wis. The steaks were aged for 35 days prior to processing. This exemplary high pressure pasteurization processing including steaks to 87,000 psi for one minute.

The steaks were then tested for aerobic plate count on an external surface using a swab sample, and internally tested using a gram sample.

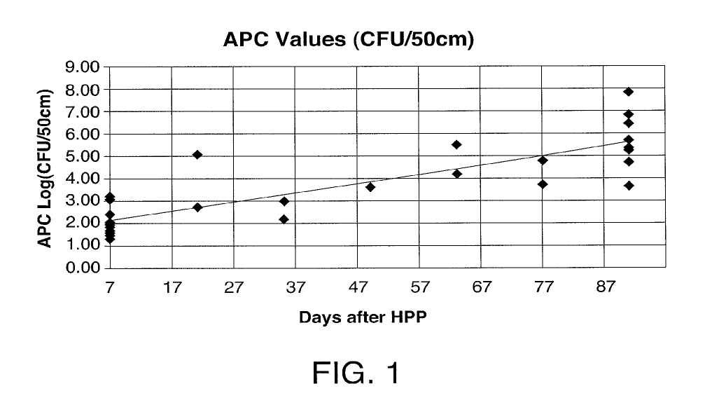

FIG. 1 above shows actual log values of aerobic plate counts. The values were calculated CFU/50-cm² due to the low counts after high pressure pasteurization. If counts were shown in CFU-cm² values, values would have been too low to report until later in the study. After 91 days of aged high pressure pasteurization processing, there was a mean log ape value of 3.98 CFU-cm².

### Example 2

USDA select beef, strip loins were procured. Strips were trimmed of external fat according to standard industry practices, leaving approximately ⅛″ of external fat. The strip loins were tenderized using needle tenderization according to standard industry practices a single time using a Ross TC700W; www.rossindinc.com. The strip loin was then injected using a Schroeder IMAX 430 with a solution of water, salt, and sodium phosphate up to 12%. The strip loins were then aged 14 days according to standard industry practices and then portioned into one inch steaks using a band saw with a boneless blade. The steaks were packaged in a four across using a Multi-Vac roll stock machine, model R230.

High pressure pasteurization processing was performed at the American Pasteurization Company facility in Milwaukee, Wis. The steaks were aged for 26 days prior to processing. This exemplary high pressure pasteurization processing including steaks to 87,000 psi for one minute.

The steaks were then tested for aerobic plate count on an external surface using a swab sample, and internally tested using a gram sample.

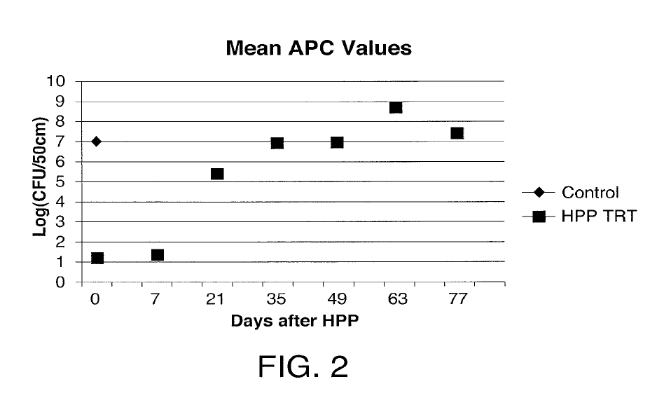

FIG. 2 shows actual log values of aerobic plate counts. The values were calculated CFU/50-cm² due to the low counts after high pressure pasteurization. If counts were shown in CFU-cm² values, values would have been too low to report until later in the study. After 77 days of aged high pressure pasteurization processing, there was a mean log ape value of 5.71 CFU-cm².

The processes described herein have now been described with reference to several embodiments thereof. The entire disclosure and any patents, patent applications (including provisional applications), and publications cited herein are incorporated by reference as if individually incorporated for all purposes. Unless otherwise indicated, all parts and percentages arc by weight and all molecular weights are weight average molecular weights. The foregoing detailed description has been given for clarity of understanding only. No unnecessary limitations are to be understood therefrom. It will be apparent to those skilled in the art that many changes can be made in the embodiments described without departing from the scope of the processes described herein. Thus, the invention is not limited to the exact details shown and described, for variations obvious to one skilled in the art will be included within the invention defined by the claims.

Unless otherwise indicated, all numbers expressing quantities of ingredients, properties such as molecular weight, percentages, reaction conditions, temperature, and so forth used in the specification and claims are to be understood as being modified by the term “about.” Accordingly, unless indicated to the contrary, the numerical parameters set forth are approximations that may depend upon the desired properties sought.

What is claimed is:

1. A process for preserving fresh meat comprising the steps of:
a) packaging the fresh meat in a sealed package;
b) placing the packaged fresh meat in a pressurization vessel and closing the vessel;
c) pressurizing the vessel containing the packaged fresh meat to an elevated pressure of at least 50,000 psi so that the packaged fresh meat is placed under elevated pressure;
d) maintaining the elevated pressure on the packaged fresh meat for a time of from about 1 to about 300 seconds and at a temperature of from −2° C. to 8° C.;
e) reducing the pressure on the packaged fresh meat to ambient pressure; and
f) removing the fresh meat from the pressurization vessel.

2. The process of claim 1, wherein the elevated pressure is from 60,000 to 90,000 psi.

3. The process of claim 1, wherein the elevated pressure is from 70,000 to 87,000 psi.

4. The process of claim 1, wherein the packaged fresh meat is under elevated pressure for a time from 30 seconds to 150 seconds.

5. The process of claim 1, wherein the packaged fresh meat is under elevated pressure for a time from 45 seconds to 70 seconds.

6. The process of claim 1, wherein the fresh meat comprises beef.

7. The process of claim 1, wherein the fresh meat has been placed under vacuum in the sealed package.

8. The process of claim 1, wherein the fresh meat is packaged in a sealed package having an oxygen displaced gas environment.

9. The process of claim 8, wherein the gas environment comprises a gas selected from carbon dioxide, carbon monoxide, nitrogen, nitrous, oxide, hydrogen, neon, argon, krypton, xenon and mixtures thereof.

10. The process of claim 1, wherein the fresh meat is free of non-endogenous antimicrobial treatments.

11. The process of claim 1, wherein the elevated pressure is maintained on the packaged fresh meat for a time of from about 1 to about 300 seconds and at a temperature of from about −1.11° C. to about 7.22° C.;
